(19) United States
(12) Patent Application Publication
(10) Pub. No.: US 2026/0301074 A1
(43) Pub. Date: Oct. 1, 2026

(54) DETERMINATION DEVICE, DETERMINATION METHOD, AND NON-TRANSITORY COMPUTER-READABLE MEDIUM

(71) Applicant: NEC Corporation, Tokyo (JP)

(72) Inventors: Takumi OKAZAWA, Tokyo (JP); Nobutatsu Nakamura, Tokyo (JP); Sho Shibata, Tokyo (JP); Haruna Imai, Tokyo (JP)

(73) Assignee: NEC Corporation, Tokyo (JP)

(21) Appl. No.: 19/630,655

(22) Filed: Mar. 27, 2026

(30) Foreign Application Priority Data
Mar. 31, 2025 (JP) 2025-057944

(51) Int. Cl. G06Q 40/06

(52) U.S. Cl. CPC G06Q 40/062

(57) ABSTRACT

A determination device capable of efficiently determining a portfolio is implemented. A determination device includes a learning unit for creating a model representing a relationship between a portfolio representing a configuration of a plurality of stocks and a target indicator value representing an intended indicator value, and an evaluation representing goodness of the portfolio, based on data including the portfolio and the target indicator value, and a determination unit for determining a portfolio whose evaluation rises using the model, in which the evaluation includes error information indicating a degree of deviation between an indicator of the portfolio and a target indicator value, and cost information indicating a transaction cost required for recombining the plurality of stocks.

### INCORPORATION BY REFERENCE

This application is based upon and claims the benefit of priority from Japanese patent application No. 2025-057944, filed on Mar. 31, 2025, the disclosure of which is incorporated herein in its entirety by reference.

### TECHNICAL FIELD

The present disclosure relates to a determination device, a determination method, and a non-transitory computer-readable medium.

### BACKGROUND ART

A technology for determining a portfolio using a computer is known. An example of a technology for determining a portfolio using a computer is the technology described in JP 2002-297896, for example.

In the technology described in JP 2002-297896, in order to determine a portfolio, an operation using a quadratic programming method, a Markov chain model, or the like is performed. At this time, for example, there is a problem that the calculation cost becomes enormous in a case where the evaluation expression becomes complicated.

### SUMMARY

The present disclosure has been made in view of the above problems, and an example object thereof is to provide a technology for efficiently determining a portfolio.

A determination device according to an example aspect of the present disclosure includes a learning means for creating a model representing a relationship between a portfolio representing a configuration of a plurality of stocks and a target indicator value representing an intended indicator value, and an evaluation representing goodness of the portfolio, based on data including the portfolio and the target indicator value, and a determination means for determining a portfolio whose evaluation rises using the model, in which the evaluation includes error information indicating a degree of deviation between an indicator of the portfolio and a target indicator value, and cost information indicating a transaction cost required for recombining the plurality of stocks.

A determination method according to an example aspect of the present disclosure includes a learning process of creating a model representing a relationship between a portfolio representing a configuration of a plurality of stocks and a target indicator value representing an intended indicator value, and an evaluation representing goodness of the portfolio, based on data including the portfolio and the target indicator value, and a determination process of determining a portfolio whose evaluation rises using the model, in which the evaluation includes error information indicating a degree of deviation between an indicator of the portfolio and a target indicator value, and cost information indicating a transaction cost required for recombining the plurality of stocks.

A non-transitory computer-readable medium according to an example aspect of the present disclosure stores a determination program for causing a computer to execute a learning process of creating a model representing a relationship between a portfolio representing a configuration of a plurality of stocks and a target indicator value representing an intended indicator value, and an evaluation representing goodness of the portfolio, based on data including the portfolio and the target indicator value, and a determination process of determining a portfolio whose evaluation rises using the model, in which the evaluation includes error information indicating a degree of deviation between an indicator of the portfolio and a target indicator value, and cost information indicating a transaction cost required for recombining the plurality of stocks.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of a determination device according to the present disclosure;

FIG. 2 is a flowchart illustrating a flow of a determination method according to the present disclosure;

FIG. 3 is a block diagram illustrating a configuration of the determination device according to the present disclosure;

FIG. 4 is a diagram illustrating an example of management of a portfolio;

FIG. 5 is a flowchart illustrating a flow of the determination method according to the present disclosure;

FIG. 6 is a block diagram illustrating a configuration of the determination device according to the present disclosure;

FIG. 7 is a diagram for explaining selection of a portfolio by the determination device according to the present disclosure;

FIG. 8 is a block diagram illustrating a configuration of the determination device according to the present disclosure;

FIG. 9 is a graph illustrating a result of the determination method according to the present disclosure;

FIG. 10 is a graph illustrating a result of the determination method according to the present disclosure;

FIG. 11 is a graph illustrating a result of the determination method according to the present disclosure;

FIG. 12 is a graph illustrating a result of the determination method according to the present disclosure; and

FIG. 13 is a block diagram illustrating a configuration of a computer that functions as the determination device according to the present disclosure.

### EXAMPLE EMBODIMENT

Hereinafter, example embodiments of the present invention will be exemplified. However, the present invention is not limited to the following exemplary example embodiments, and various modifications can be made within a scope described in the claims. For example, example embodiments obtained by appropriately combining technologies (some or all of things or methods) adopted in the following exemplary example embodiments can also be included in the scope of the present invention. Example embodiments obtained by appropriately omitting some of the technologies adopted in the following exemplary example embodiments can also be included in the scope of the present invention. Effects mentioned in the following exemplary example embodiments are examples of effects expected in the exemplary example embodiments, and do not define extension of the present invention. In other words, example embodiments that do not provide the effects mentioned in the following exemplary example embodiments can also be included in the scope of the present invention.

### First Exemplary Example Embodiment

A first exemplary example embodiment that is an example of the example embodiments of the present invention will be described in detail with reference to the drawings. The present exemplary example embodiment is a basic form of each exemplary example embodiment to be described below. An application range of each technology adopted in the present exemplary example embodiment is not limited to the present exemplary example embodiment. In other words, each technology adopted in the present exemplary example embodiment can also be adopted in another exemplary example embodiment included in the present disclosure within a range in which no particular technical problem occurs. Each technology illustrated in the drawings referred to for describing the present exemplary example embodiment can also be adopted in another exemplary example embodiment included in the present disclosure within a range in which no particular technical problem occurs.

### (Configuration of Determination Device)

A configuration of a determination device 1 will be described with reference to FIG. 1. FIG. 1 is a block diagram illustrating the configuration of the determination device 1. As illustrated in FIG. 1, the determination device 1 includes a learning unit 11 and a determination unit 12.

The learning unit 11 creates a model representing the relationship between the portfolio and the target indicator value, and the evaluation representing the goodness of the portfolio, based on the data including the portfolio representing the configuration of the plurality of stocks and the target indicator value representing an intended indicator value.

The determination unit 12 determines a portfolio whose evaluation rises, using a model created by the learning unit 11.

The “portfolio” represents a configuration of a plurality of stocks. A “stock” refers to an individual financial product, such as shares, insurance, low current assets, etc. For example, in the case of a share, the brand refers to a share issued by a specific company, and is specified by a company name, a code, and the like. The “configuration of a plurality of stocks” indicates a combination of a plurality of stocks included in the portfolio and the number of units of each stock.

The “indicator value” refers to a value of an indicator serving as a benchmark of the market, and for example, a well-known index such as TOPIX (registered trademark) or Nikkei Stock Average (registered trademark) may be used, or a unique index obtained from an average or a weighted average of a specific combination of stocks may be used. The “intended indicator value” refers to an indicator value to be followed by the profit rate of a portfolio among the indicator values.

The “evaluation indicating the goodness of the portfolio” is obtained by evaluating the portfolio from one or more viewpoints, and includes at least error information and cost information.

The error information is also referred to as a tracking error, and represents the degree of deviation between the indicator of the portfolio and the target indicator value. The indicator of the portfolio indicates, for example, the profit rate of the portfolio. The degree of deviation between the indicator of the portfolio and the target indicator value is represented by, for example, a difference between the profit rate of the portfolio and the profit rate of the target indicator value over a predetermined period. The portfolio is rated “good” as the profit rate of the portfolio follows the profit rate of the target indicator value.

The cost information represents the cost of a transaction required to recombine a stock from a current portfolio to build a (next) portfolio. “Transaction required for recombining” means the sale of owned stocks and the purchase of stocks from the market. The “transaction cost” includes a fee paid to a securities company or the like. A portfolio is evaluated “better” in a case where the cost of a transaction required to recombine a stock from a current portfolio is lower.

By using the data including the current portfolio and the target indicator value, the learning unit 11 can calculate error information indicating the degree of deviation from the target indicator value and cost information related to recombination from the current portfolio. As a result, the learning unit 11 can calculate the evaluation including the error information and the cost information, and can create a model representing the relationship between the portfolio and the target indicator value, and the evaluation. The determination unit 12 can determine a portfolio whose evaluation rises using such a model.

### (Effect of Determination Device)

As described above, the determination device 1 adopts a configuration in which a model representing a relationship between a portfolio and a target indicator value, and an evaluation of the portfolio is created, and a portfolio whose evaluation rises is determined using the model. Therefore, according to the determination device 1, an effect that the portfolio can be efficiently determined can be obtained.

### (Flow of Determination Method)

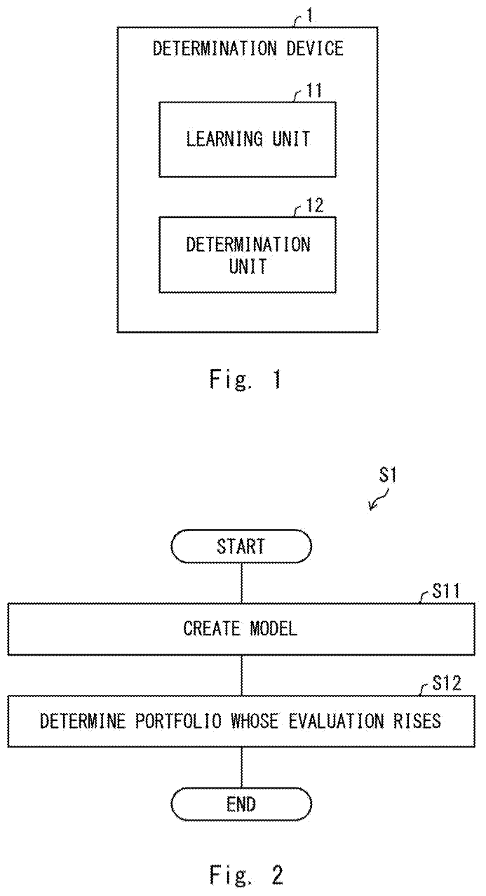

A flow of a determination method S1 will be described with reference to FIG. 2. FIG. 2 is a flowchart illustrating the flow of the determination method S1. As illustrated in FIG. 2, the determination method S1 includes a learning process S11 and a determination process S12.

In the learning process S11, the determination device 1 creates a model representing the relationship between the portfolio and the target indicator value and the evaluation representing the goodness of the portfolio based on the data including the portfolio representing the configuration of the plurality of stocks and the target indicator value representing the intended indicator value.

In the determination process S12, the determination device 1 determines a portfolio whose evaluation rises using the model created by the learning unit 11. The evaluation includes error information and cost information. The error information indicates the degree of deviation between the indicator of the portfolio and the target indicator value. The cost information represents the cost of a transaction required to recombine a plurality of stocks constituting the portfolio.

### (Effect of Determination Method)

As described above, the determination method S1 adopts a configuration in which a model representing a relationship between a portfolio and a target indicator value, and an evaluation of the portfolio is created, and a portfolio whose evaluation rises is determined using the model. Therefore, according to the determination method S1, an effect that the portfolio can be efficiently determined can be obtained.

### Second Exemplary Example Embodiment

A second exemplary example embodiment that is an example of the example embodiments of the present invention will be described in detail with reference to the drawings. Components that have the same functions as the components described in the above-described exemplary example embodiment are denoted by the same reference signs, and description of the components will be appropriately omitted. An application range of each technology adopted in the present exemplary example embodiment is not limited to the present exemplary example embodiment. In other words, each technology adopted in the present exemplary example embodiment can also be adopted in another exemplary example embodiment included in the present disclosure within a range in which no particular technical problem occurs. Each technology illustrated in each of the drawings referred to for describing the present exemplary example embodiment can also be adopted in another exemplary example embodiment included in the present disclosure within a range in which no particular technical problem occurs.

### (Configuration of Determination Device)

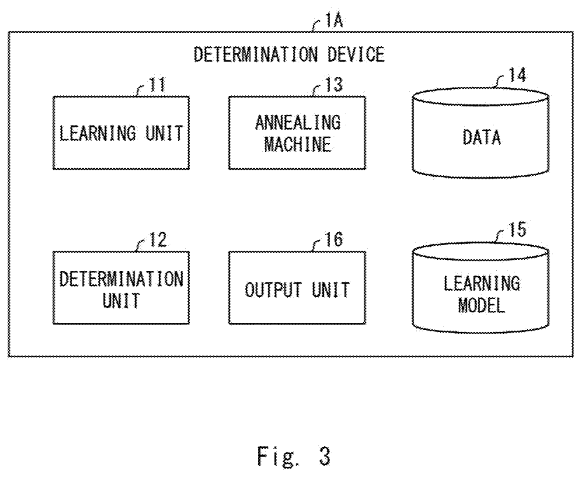

A configuration of a determination device 1A will be described with reference to FIG. 3. FIG. 3 is a block diagram illustrating the configuration of the determination device 1A. The determination device 1A includes an annealing machine 13 and an output unit 16 in addition to the learning unit 11 and the determination unit 12 included in the determination device 1, and stores data 14 and a learning model 15.

The annealing machine 13 is an arithmetic unit that executes an operation for obtaining a ground state of the Hamiltonian of the Ising model. The annealing machine 13 is a vector computer on which a pseudo quantum annealing method is implemented or a quantum computer on which a quantum annealing method is implemented. The annealing machine 13 is not limited to a vector computer and a quantum computer, and may be a parallel computer, a graphic board, or the like.

The data 14 is data including a portfolio and a target indicator value. For example, the data 14 may include information indicating the configuration of the current portfolio and information indicating the target indicator value. The data 14 may include information indicating changes in past values of all stocks to be traded and changes in past values of all indicator values.

The learning model 15 is a machine learning model learned to create a model representing the relationship between the portfolio and the target indicator value, and the evaluation indicating the goodness of the portfolio. The machine learning model may be any machine learning model that can output a model that can be converted into an Ising model, and examples thereof include a factorization machine, a restricted Boltzmann machine, an ensemble learning device, and a linear regression learning device.

The output unit 16 outputs the portfolio determined by the determination unit 12. The output unit 16 may display the portfolio determined by the determination unit 12 on a display unit (not illustrated), may store the portfolio in a storage device (not illustrated), or may transmit the portfolio to another device via a communication unit (not illustrated).

### (Application of Determination Device)

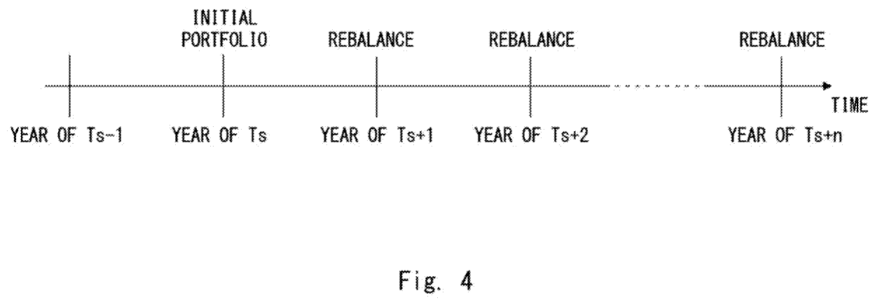

FIG. 4 is a diagram illustrating an example of management of a portfolio. In one example, the portfolio may be periodically rebalanced (change the configuration of the portfolio). In the example illustrated in FIG. 4, the first portfolio is determined in the year of Ts, and rebalancing is performed every year. The cycle of the rebalancing is not particularly limited, and the rebalancing may be performed aperiodically. The determination device 1A is used to determine the next portfolio or a candidate thereof at the time of rebalancing.

### Description of Terms

Next, before describing the operation of the determination device 1A, terms will be described. Hereinafter, the error information may be referred to as a “tracking error”, the cost information may be referred to as a “rebalance cost”, and the target indicator value may be referred to as an “index”.

First, a tracking error (error information) will be described. The tracking error only needs to indicate the degree of deviation between the indicator of the portfolio and the index, and can be calculated as follows, for example.

In one example, the tracking error can be the standard deviation of the difference between the logarithm of the profit rate of the index and the logarithm of the profit rate of the portfolio. Such a tracking error can be calculated as follows.

First, the return “R_{i,t}” of the index at the t-th week can be represented as the following Expression (1), where “Iₜ” is a value at the t-th week of the index.

$$\begin{matrix}[ Math . 1 ] & \\ {R}_{I , t} = log ( \frac{{I}_{t}}{{I}_{t - 1}} ) & ( 1 )\end{matrix}$$

“Return” represents the logarithm of the profit rate (the ratio of the value at t-th week to the value at (t−1)th week).

The return “R_{v,t}” of the portfolio can be represented as the following Expression (2), where “Vₜ” is a value of the t-th week of the portfolio (the total value of each stock included in the portfolio).

$$\begin{matrix}[ Math . 2 ] & \\ {R}_{V , t} = log ( \frac{{V}_{t}}{{V}_{t - 1}} ) & ( 2 )\end{matrix}$$

Here, “Vₜ” can be represented as the following Expression (3).

$$\begin{matrix}[ Math . 3 ] & \\ {V}_{t} = c {Σ}_{m ∈ M} {P}_{m ( t )} {p}_{r , m} & ( 3 )\end{matrix}$$

“c” is a predetermined constant. “M” is a set of stocks to be considered. “m” represents a stock. “Pₘ₍ₜ₎” indicates the value of the stock m at t-th week. “Pᵣ” represents a vector indicating a constituent ratio of each stock in the portfolio. The constituent ratio “P_{r,m}” of the stock m can be represented by the following Expression (4).

$$\begin{matrix}[ Math . 4 ] & \\ {p}_{r , m} = {Σ}_{i} {a}_{i} {s}_{m , i} / {Σ}_{{m}^{′}} {Σ}_{i} {a}_{i} {s}_{{m}^{′} , i} & ( 4 )\end{matrix}$$

“aᵢ” indicates the number of units of a stock included in the portfolio. The unit can be, for example, 100. “aᵢ” can be selected from Nₐ options. A set A of selectable options is represented by the following Expression (5).

$$\begin{matrix}[ Math . 5 ] & \\ A = \{ {a}_{0} , {a}_{1} , {a}_{2} , {a}_{3} , … , {a}_{{N}_{a} - 1} \} , {a}_{0} = 0 & ( 5 )\end{matrix}$$

Not freely setting the number of purchase units of each stock in this manner but selecting from predetermined options is also referred to as “encoding constraint”.

“S_{m,i}” is a decision variable (binary variable) that is “1” in a case where the portfolio includes the stock m in units of aᵢ (for example, 100aᵢ), and “0” in a case where the portfolio does not include the stock m.

In one example, the function “E(Pᵣ)” for calculating the tracking error of the portfolio can be represented as the following Expression (6). In the following Expression (6), the tracking error is represented by the standard deviation of the difference between the return of the index and the return of the portfolio.

$$\begin{matrix}[ Math . 6 ] & \\ E ( {p}_{r} ) = \sqrt{Variance [ {\{ {d}_{t} \}}_{t ∈ T} ]} = \sqrt{Variance [ {\{ {R}_{I , t} - {R}_{V , t} \}}_{t ∈ T} ]} = \sqrt{\frac{1}{\vert T \vert} {\sum }_{t ∈ T} {( log ( \frac{{I}_{t}}{{I}_{t - 1}} ) - log ( \frac{{V}_{t}}{{V}_{t - 1}} ) - \overline{log ( \frac{{I}_{t}}{{I}_{t - 1}} ) - log ( \frac{{V}_{t}}{{V}_{t - 1}} )} )}^{2}} & ( 6 )\end{matrix}$$

“T” is a set of weeks in which value data of each stock exists.

Next, the rebalance cost (cost information) will be described. Since the rebalance cost, which is a cost related to the rebalance of the portfolio, is generally proportional to the trading amount of the stock to be recombined, the rebalance cost may be calculated by the trading amount. In this case, since the portfolio is determined so as to minimize the trading amount, there is an effect of suppressing a change from the current portfolio.

In one example, the function “C(pₐ)” for calculating the rebalance cost can be represented as the following Expression (7).

$$\begin{matrix}[ Math . 7 ] & \\ C ( {p}_{a} ; {q}_{a} ) = {\sum }_{m ∈ M} {P}_{m} \times abs ( {\sum }_{i = 0}^{{N}_{a} - 1} {a}_{i} {s}_{m , i} - {q}_{a , m} ) & ( 7 )\end{matrix}$$

“pₐ” indicates a purchase amount vector of the portfolio. The purchase amount “P_{a,m}” of the stock m is represented by the following Expression (8).

$$\begin{matrix}[ Math . 8 ] & \\ {p}_{a . m} = {P}_{m} {Σ}_{i} 100 {a}_{i} {s}_{m , i} & ( 8 )\end{matrix}$$

“qₐ” indicates the number of units of each stock included in the current portfolio. The number of units of the stock m is indicated as “q_{a,m}”. “abs( )” represents an absolute value.

Next, the evaluation indicating the goodness of the portfolio will be described. The evaluation may be based on the tracking error and the rebalance cost, but in one example, the evaluation may be a weighted sum of the tracking error and the rebalance cost.

Here, a function for calculating the evaluation is referred to as a black box function. A black box function f can be represented as the following Expression (9)

$$\begin{matrix}[ Math . 9 ] & \\ f ( {p}_{a} , {p}_{r} ; α , β ) = αE ( {p}_{r} ) + βC ( {p}_{a} ) & ( 9 )\end{matrix}$$

α and β are positive constants indicating weights. In a case where the first portfolio is determined, the rebalance cost as β0 can be ignored.

There is an increasing demand for index funds among investors. In the management of the index fund, there is a need to suppress the rebalance cost while following the index. The tracking error for the index indicates the degree to which the change in the profit rate of the portfolio deviates from the change in the profit rate of the index (if this is large, it is considered that the investment risk is large). In a case where the tracking error increases, the tracking error can be reduced by recombining the portfolio to an appropriate product. However, if the amount of portfolio recombination increases, the cost (rebalance cost) also increases. Therefore, in order to solve the contradictory problem of reducing the tracking error and suppressing the rebalance cost, evaluation including both the tracking error (error information) and the rebalance cost (cost information) is used.

The “cardinality constraint” is a constraint that limits the number of stocks constituting a portfolio. The “encoding constraint” and the “cardinality constraint” are constraints for adjusting the calculation cost, and may be appropriately set according to the calculation capability of the annealing machine to be used.

### (Operation of Determination Device)

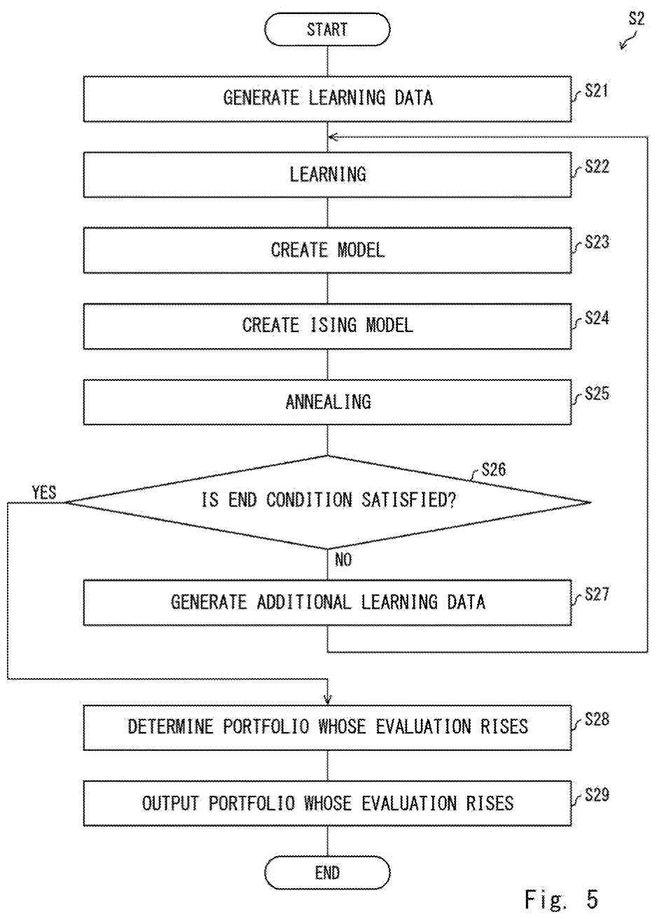

FIG. 5 is a flowchart illustrating a flow of a determination method S2 executed by the determination device 1A. As illustrated in FIG. 4, the determination method S2 includes a learning data generation process S21, a learning process S22, a model creation process S23, an Ising model creation process S24, an annealing process S25, an end condition determination process S26, an additional learning data generation process S27, and a high-evaluation portfolio determination process S28.

In the learning data generation process S21, the learning unit 11 generates first learning data. For example, the learning unit 11 first generates one or more portfolios x₀. As the one or more portfolios x₀, a predetermined portfolio may be used or randomly generated. Then, the learning unit 11 refers to the data 14 and calculates the evaluation y₀ of each portfolio x₀ using the black box function f. Then, the learning unit 11 generates a set (x₀, y₀) of each portfolio x₀ and the evaluation y₀ of the portfolio as the first learning data.

Subsequently, in the learning process S22, the learning unit 11 causes the learning model 15 to learn using the learning data. For example, in a case where the learning model 15 is a factorization machine, the model parameters w and v are determined.

Subsequently, in the model creation process S23, the learning unit 11 uses the learning model 15 to create a model representing the relationship between the portfolio and the target indicator value, and the evaluation indicating the goodness of the portfolio. For example, in a case where the learning model 15 is a factorization machine, the learning model 15 outputs a function “y(s)” that approximates the black box function f related to the target indicator value as the model. The function y(s) is used instead of the black box function f in annealing to be described later, and thus is also referred to as a “proxy function” below. The proxy function y(s) can be formulated as the following Expression (10).

$$\begin{matrix}[ Math . 10 ] & \\ y ( s : c , w , v ) = c + {\sum }_{i , m} {w}_{i , m} {s}_{i , m} + {\sum }_{i . m} {\sum }_{{i}^{′} , {m}^{′}} {\sum }_{k = 1}^{K} {v}_{i , m , k} {v}_{{i}^{′} , {m}^{′} , k} {s}_{{i}^{′} , {m}^{′}} & ( 10 )\end{matrix}$$

Subsequently, in the Ising model creation process S24, the determination unit 12 creates an Ising model by converting the model created by the learning unit 11 into an Ising model. The determination unit 12 may reflect constraint conditions such as a cardinality constraint and an encoding constraint on the Ising model. As a result, the constraint conditions can be applied to the annealing machine 13.

In one example, the cardinality constraint in which the number of stocks constituting the portfolio is k can be formulated as the following Expression (11).

$$\begin{matrix}[ Math . 11 ] & \\ \{ \begin{matrix}{( {\sum }_{i = 1}^{{N}_{a} - 1} {\sum }_{m ∈ M} {s}_{m , i} - k )}^{2} & if \vert M \vert > k \\ {s}_{m , 0} = 0 , ∀ m & otherwise\end{matrix} & ( 11 )\end{matrix}$$

In one example, the encoding constraint for selecting the number of purchase units of each stock from Nₐ options can be formulated as the following Expression (12).

$$\begin{matrix}[ Math . 12 ] & \\ {\sum }_{m ∈ M} {( {\sum }_{i = 0}^{{N}_{a} - 1} {s}_{m , i} - 1 )}^{2} & ( 12 )\end{matrix}$$

Subsequently, in the annealing process S25, the determination unit 12 inputs the Ising model to the annealing machine 13 to obtain the solution (portfolio) obtained by the annealing machine 13.

In the end condition determination process S26, the determination unit 12 determines whether the solution (portfolio) obtained in the immediately preceding annealing process S25 satisfies a predetermined end condition. Examples of the predetermined end condition include, but are not limited to, the following conditions or a combination thereof.
The annealing process is repeated equal to or more than a predetermined number of times.
The evaluation calculated from the obtained solution (portfolio) is equal to or more than a predetermined level.

In a case where it is determined in the end condition determination process S26 that the end condition is not satisfied, the additional learning data generation process S27 is executed. In the additional learning data generation process S27, the learning unit 11 refers to the data 14 and calculates the evaluation y′ for the solution (portfolio) x′ obtained in the immediately preceding annealing process S25 using the black box function f. Then, the learning unit 11 generates a set of the portfolio x′ and the evaluation y′ as additional learning data. Then, the process returns to the learning process S22 to repeat the process.

In a case where it is determined that the end condition is satisfied in the end condition determination process S26, the high-evaluation portfolio determination process S28 is executed. In the high-evaluation portfolio determination process S28, the determination unit 12 determines the solution (portfolio) obtained in the previous annealing process S25 as a portfolio for increasing the evaluation.

Then, the output unit 16 outputs the high-evaluation portfolio determined by the determination unit 12.

### (Effect of Determination Device)

The development of current index portfolio products generally uses the beta indicator, which is a parameter obtained by weighting the correlation coefficient of the index with the risk coefficient. The beta indicator does not calculate a correlation of a stock to be selected or a comprehensive difference from a target index, and thus is a fairly rough approximation. The correlation of a stock to be selected is a combination optimization problem, and the comprehensive difference from an index is nonlinear in the objective function expression. Therefore, in a case where both are combined, a complicated model is obtained, and it may be difficult to create an approximate model.

On the other hand, in the determination device 1A, the learning unit 11 can efficiently create an approximate model by machine learning even for a complicated model.

As described above, in the determination device 1A, a configuration is adopted in which the portfolio is determined by inputting, to the annealing machine, the Ising model based on the model representing the relationship between the portfolio and the target indicator value, and the evaluation indicating the goodness of the portfolio. Therefore, according to the determination device 1A, it is possible to efficiently determine a portfolio whose evaluation rises.

The determination device 1A employs a configuration in which a constraint condition for limiting the number of stocks constituting a portfolio is applied to an annealing machine. Therefore, according to the determination device 1A, an effect that the calculation cost can be adjusted can be obtained.

The determination device 1A employs a configuration in which the error information represents the standard deviation of the difference between the logarithm of the profit rate of the target indicator value and the logarithm of the profit rate of the portfolio. Therefore, according to the determination device 1A, it is possible to obtain an effect that the portfolio can be determined based on more appropriate evaluation in addition to the effect obtained by the determination device 1.

### Third Exemplary Example Embodiment

A third exemplary example embodiment that is an example of an example embodiment of the present invention will be described in detail with reference to the drawings. Constituents that have the same functions as the constituents described in the above-described exemplary example embodiment are denoted by the same reference numerals, and the description of the constituents will be appropriately omitted. An application range of each technology adopted in the present exemplary example embodiment is not limited to the present exemplary example embodiment. In other words, each technology adopted in the present exemplary example embodiment can also be adopted in another exemplary example embodiment included in the present disclosure within a range in which no particular technical problem occurs. Each technology illustrated in each of the drawings referred to for describing the present exemplary example embodiment can be adopted in the other exemplary example embodiments included in the present disclosure within a range in which no particular technical problem occurs.

### (Configuration of Determination Device)

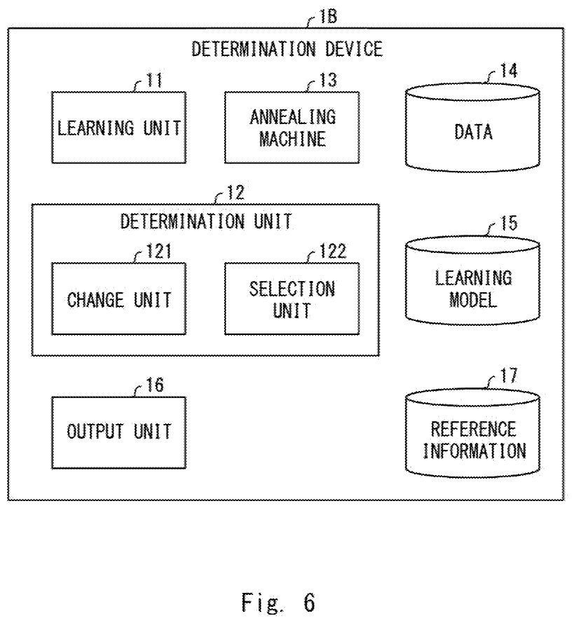

A configuration of a determination device 1B will be described with reference to FIG. 6. FIG. 6 is a block diagram illustrating the configuration of the determination device 1B. The determination device 1B is different from the determination device 1A in that reference information 17 is stored, and the determination unit 12 includes a change unit 121 and a selection unit 122.

The change unit 121 changes the weighting of the cost information with respect to the error information in the evaluation, and causes the learning unit 11 and the determination unit 12 to execute the above-described determination method S2. For example, in a case where the evaluation is obtained by the following Expression (9) described above, the change unit 121 changes the values of α and β and causes the learning unit 11 and the determination unit 12 to execute the determination method S2. As a result, the determination unit 12 can determine a plurality of portfolios. Each of the determined portfolios has a different balance between emphasis on followability to the target indicator value and emphasis on cost required for recombination. By determining a plurality of portfolios by the change unit 121, it is possible to search for a plurality of optimal solutions (multi-objective optimal solutions) that can achieve both reduction in the rebalance cost and reduction in the tracking error.

The selection unit 122 selects one portfolio from the plurality of portfolios determined by the determination unit 12 based on the reference information 17 indicating a predetermined ratio between the error information and the cost information.

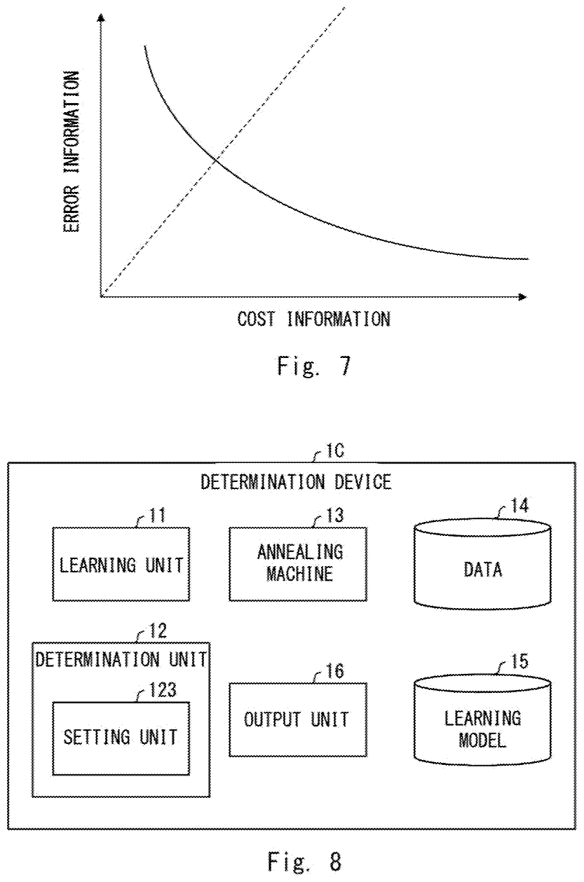

FIG. 7 is a diagram for explaining selection by the selection unit 122. In FIG. 7, a solid line is a plot of error information and cost information in the evaluation of the plurality of portfolios determined by the determination unit 12 (Pareto frontier of the multi-objective optimal solution). The dotted line represents the ratio indicated by the reference information 17. The selection unit 122 selects a portfolio (in FIG. 7, the portfolio is close to the intersection of the solid line and the dotted line) in which the ratio between the error information and the cost information in the evaluation of each portfolio is close to the ratio indicated by the reference information 17, from among the plurality of portfolios determined by the determination unit 12. Accordingly, an appropriate portfolio can be selected.

Here, the reference information 17 may indicate a predetermined ratio between the error information and the cost information, but for example, may indicate a ratio calculated based on a portfolio created in the past. For example, it may indicate (the average of) the ratio between the error information and the cost information in the evaluation of one or a plurality of past portfolios with good management profit. The reference information 17 is obtained by accumulating portfolios created in the past, and the selection unit 122 may calculate (the average of) the ratio between the error information and the cost information in the evaluation of one or a plurality of past portfolios with good management profits accumulated in the reference information 17.

The output unit 16 may output all of the plurality of portfolios determined by the determination unit 12, may output only one portfolio selected by the selection unit 122, or may output all of the plurality of portfolios determined by the determination unit 12 and highlight and output one portfolio selected by the selection unit 122.

The determination unit 12 may not include the selection unit 122.

In the determination device 1B, a configuration is adopted in which the determination unit 12 changes the weighting of the cost information with respect to the error information in the evaluation to determine a plurality of portfolios. Therefore, according to the determination device 1B, in addition to the effect exhibited by the determination device 1A, it is possible to determine a plurality of portfolios and select a portfolio according to a purpose or the like.

In the determination device 1B, a configuration is adopted in which the determination unit 12 selects one portfolio from a plurality of portfolios based on reference information indicating a predetermined ratio between error information and cost information. Therefore, according to the determination device 1B, an effect that an appropriate portfolio can be selected can be obtained.

### Fourth Exemplary Example Embodiment

A fourth exemplary example embodiment that is an example of an example embodiment of the present invention will be described in detail with reference to the drawings. Components having the same functions as the components described in the above-described exemplary example embodiment are denoted by the same reference numerals, and the description thereof will be appropriately omitted. An application range of each technology adopted in the present exemplary example embodiment is not limited to the present exemplary example embodiment. In other words, each technology adopted in the present exemplary example embodiment can also be adopted in another exemplary example embodiment included in the present disclosure within a range in which no particular technical problem occurs. Each technology illustrated in each of the drawings referred to for describing the present exemplary example embodiment can be adopted in the other exemplary example embodiments included in the present disclosure within a range in which no particular technical problem occurs.

### (Configuration of Determination Device)

A configuration of a determination device 1C will be described with reference to FIG. 8. FIG. 8 is a block diagram illustrating a configuration of the determination device 1C. The determination device 1C is different from the determination device 1A in that the determination unit 12 includes a setting unit 123.

As described above, the learning unit 11 can efficiently create an approximate model by machine learning. Therefore, the following settings are also possible.
Determination of a portfolio targeting that profit rate of the portfolio becomes higher than the profit rate of a target indicator value by standard or more
Determination of a portfolio such that a specific stock is included in the portfolio at a fixed rate and the entire portfolio follows the target indicator value

The setting unit 123 controls the determination unit 12 to determine a portfolio according to the setting described above.

In one example, the setting unit 123 may apply, to the annealing machine 13, a constraint condition that the profit rate of the portfolio is larger than the profit rate of the target indicator value by a standard or more. That is, the setting unit 123 may include, in the constraint condition to be reflected in a case of converting the model created by the learning unit 11 into the Ising model, a constraint condition that the profit rate of the portfolio is larger than the profit rate of the target indicator value by a standard or more. As the standard, for example, a standard such as x % higher than the target indicator value or y yen (or other currency) higher than the target indicator value can be used.

Furthermore, the setting unit 123 may determine whether a solution is obtained from the annealing machine 13 by applying a constraint condition to the annealing machine 13 while changing the standard, and determine a portfolio relevant to the maximum standard for obtaining a solution from the annealing machine 13.

For example, by searching for a portfolio that satisfies the standard while gradually increasing the standard, it is possible to determine a portfolio that maximizes revenue while following the index.

In another example, the setting unit 123 may apply, to the annealing machine 13, a constraint condition that a specific stock is included in the portfolio at a fixed ratio.

### EXAMPLES

A portfolio has been determined using the determination device according to the example embodiment (example), and the effect has been verified. As comparative examples, a first comparative example in which a solution is obtained by formulation by dynamic external approximation and a second comparative example in which a model approximate to a black box function is obtained by quadratic programming have been performed.

As a verification data set, Nikkei 225 has been selected as a target indicator value and 100 stocks having a high contribution degree have been selected from Nikkei 225 as target stocks, and data indicating weekly price movement for 22 years has been prepared.

Using the data for the first year, the determination device has determined the first portfolio. As the evaluation, only a tracking error (error information) has been used. Rebalancing has been performed on a one-year basis, and the portfolio for the next year has been determined by the determination device. The evaluation has been made as the sum of the weighting of the tracking error (error information) and the rebalance cost (cost information), and the weighting has been changed and the evaluation has been performed a plurality of times.

In the calculation of the evaluation and the creation of the Ising model, the above-described Expressions (1) to (12) have been used.

As the cardinality constraint, 10 and 100 have been used. The cardinality constraint 100 is equivalent to no cardinality constraint.

The ratio of the weighting coefficients of the tracking error (error information) and the rebalance cost (cost information) has been 500:1 to 100:5 in the example, 400:1 to 100:4 in the first comparative example, and 100:1 in the second comparative example.

The number of units of each stock included in the portfolio is selected from 0 to 4 units or 0 to 7 units in examples and the first comparative example. In the second comparative example, 0 to 4 units have been selected.

The number of pieces of first learning data in the example and the second comparative example has been set to 100. In the example, the learning process is repeated 200 times, and the number of additional learning data per repetition is set to 20. In the second comparative example, the learning process has been repeated 4000 times, and the number of additional learning data per repetition has been set to 1. The number of pieces of learning data in both the example and the second comparative example has been 4000.

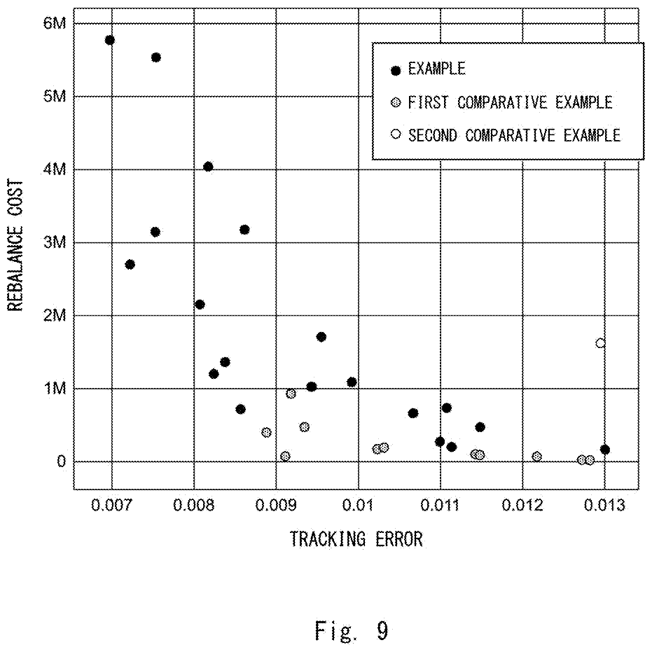

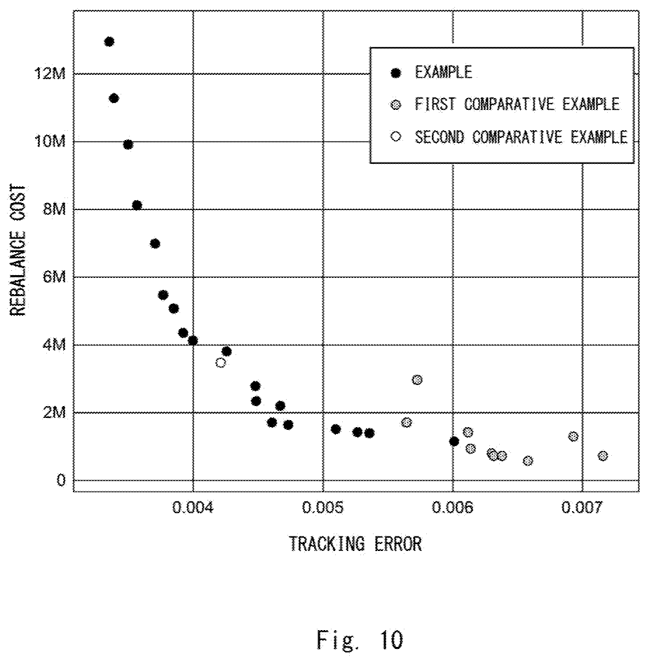

FIG. 9 is a graph illustrating values of the tracking error and the rebalance cost in a case where the weighting factor is changed with the cardinality constraint set to 10. FIG. 10 is a graph illustrating values of the tracking error and the rebalance cost in a case where the weighting factor is changed with the cardinality constraint set to 100 (without the cardinality constraint).

As illustrated in FIGS. 9 and 10, in the example, the solution is faithfully obtained with respect to the change in the weighting factor as compared with the first comparative example. In the example, in a case where there is no cardinality constraint, the solution is obtained more faithfully for the change in the weighting factor.

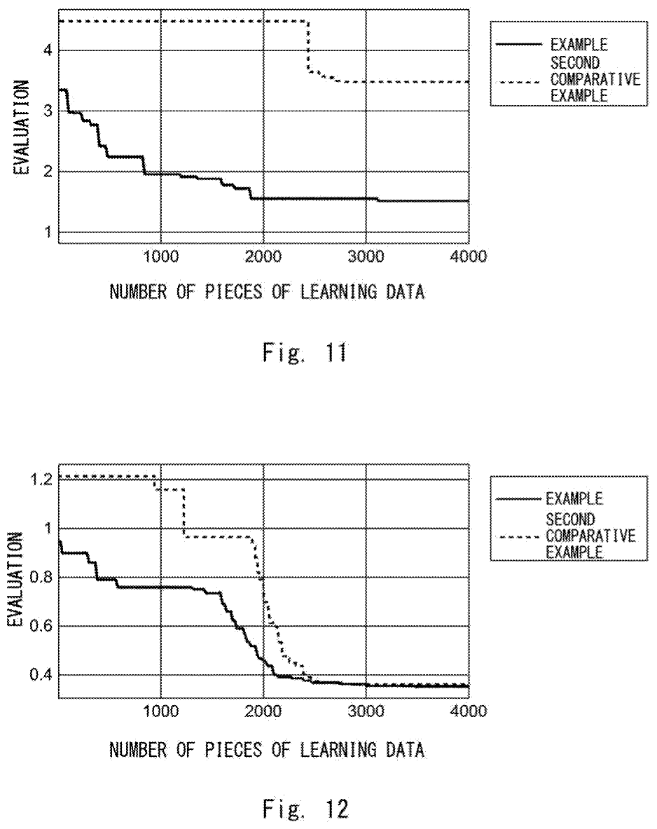

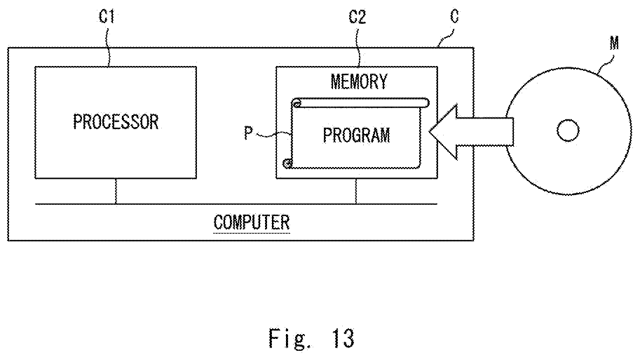

FIG. 11 is a graph illustrating the number of pieces of learning data subjected to the learning process and the transition of the evaluation of the obtained solution (portfolio) with the cardinality constraint set to 10. FIG. 12 is a graph illustrating the number of pieces of learning data subjected to the learning process and the transition of the evaluation of the obtained solution (portfolio) with the cardinality constraint set to 100 (without the cardinality constraint).

As illustrated in FIGS. 11 and 12, in the example, it can be seen that the evaluation is improved at a stage where there is less learning data than in the second comparative example.

Although data is not shown, the influence of the options of the number of units of each stock included in the portfolio on the accuracy has been small.

As described above, in the example, as shown in the above Expressions (4) to (9), even in a case where the non-linear term is included in the function for obtaining the evaluation, a well-balanced solution that is true to the weighting factor is obtained, and a solution that is good even at a stage where the learning data is small is obtained.

### [Achievement Example by Software]

Some or all of the functions of the determination devices 1, 1A, 1B, and 1C (hereinafter, also referred to as “each of the above-described devices”) may be implemented by hardware such as an integrated circuit (IC chip) or may be implemented by software.

In the latter case, each of the above devices is achieved by, for example, a computer that executes a command of a program as software for achieving each function. An example of such a computer (hereinafter described as a computer C) is illustrated in FIG. 13. FIG. 13 is a block diagram illustrating a hardware configuration of the computer C functioning as each of the above devices.

The computer C includes at least one processor C1 and at least one memory C2. A program P causing the computer C to operate as each of the above devices is recorded in the memory C2. In the computer C, the processor C1 reads the program P from the memory C2 and executes the program P to implement each function of each of the above devices.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for expanding the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, or a programmable logic circuit can be used. The computer C can acquire the program P via such a recording medium M. The program P can be transmitted via a transmission medium. As such a transmission medium, for example, a communication network or a broadcast wave can be used. The computer C can also acquire the program P via such a transmission medium.

Each of the above functions of each of the above devices may be achieved by a single processor provided in a single computer, may be achieved in cooperation with a plurality of processors provided in a single computer, or may be achieved in cooperation with a plurality of processors provided in a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in a plurality of computers.

### Supplementary Information 1

The present disclosure includes technologies described in the following supplementary notes. However, the present invention is not limited to the technologies described in the following supplementary note, and various modifications can be made within the scope described in the claims.

### Supplementary Note 1

A determination device including:
a learning means for creating a model representing a relationship between a portfolio representing a configuration of a plurality of stocks and a target indicator value representing an intended indicator value, and an evaluation representing goodness of the portfolio, based on data including the portfolio and the target indicator value; and
a determination means for determining a portfolio whose evaluation rises using the model,
in which the evaluation includes error information indicating a degree of deviation between an indicator of the portfolio and a target indicator value, and cost information indicating a transaction cost required for recombining the plurality of stocks.

### Supplementary Note 2

The determination device according to Supplementary Note 1, in which the determination means determines the portfolio by inputting an Ising model based on the model to an annealing machine.

### Supplementary Note 3

The determination device according to Supplementary Note 2, in which the determination means applies, to the annealing machine, a constraint condition that a profit rate of the portfolio is larger than a profit rate of the target indicator value by a standard or more.

### Supplementary Note 4

The determination device according to Supplementary Note 3, in which the determination means applies the constraint condition to the annealing machine while changing the standard, and determines the portfolio relevant to the maximum standard from which a solution is obtained from the annealing machine.

### Supplementary Note 5

The determination device according to Supplementary Note 2, in which the determination means applies a constraint condition that limits the number of stocks constituting the portfolio to the annealing machine.

### Supplementary Note 6

The determination device according to Supplementary Note 1, in which the error information represents a standard deviation of a difference between a logarithm of a profit rate of the target indicator value and a logarithm of a profit rate of the portfolio.

### Supplementary Note 7

The determination device according to Supplementary Note 1, in which the determination means changes weighting of the cost information with respect to the error information in the evaluation to determine the plurality of portfolios.

### Supplementary Note 8

The determination device according to Supplementary Note 7, in which the determination means selects one of the portfolios from the plurality of portfolios based on reference information indicating a predetermined ratio between the error information and the cost information.

### Supplementary Note 9

A determination method including:
a learning process of creating a model representing a relationship between a portfolio representing a configuration of a plurality of stocks and a target indicator value representing an intended indicator value, and an evaluation representing goodness of the portfolio, based on data including the portfolio and the target indicator value; and
a determination process of determining a portfolio whose evaluation rises using the model,
in which the evaluation includes error information indicating a degree of deviation between an indicator of the portfolio and a target indicator value, and cost information indicating a transaction cost required for recombining the plurality of stocks.

### Supplementary Note 10

A determination program for causing a computer to execute:
a learning process of creating a model representing a relationship between a portfolio representing a configuration of a plurality of stocks and a target indicator value representing an intended indicator value, and an evaluation representing goodness of the portfolio, based on data including the portfolio and the target indicator value; and
a determination process of determining a portfolio whose evaluation rises using the model,
in which the evaluation includes error information indicating a degree of deviation between an indicator of the portfolio and a target indicator value, and cost information indicating a transaction cost required for recombining the plurality of stocks.

### Supplementary Information 2

The present disclosure includes the technologies described in the following supplementary notes. However, the present invention is not limited to the technologies described in the following Supplementary Notes, and various modifications can be made within the scope described in the claims.

### Supplementary Note 1

A determination device including:
at least one processor, in which
the at least one processor is configured to execute:
a learning process of creating a model representing a relationship between a portfolio representing a configuration of a plurality of stocks and a target indicator value representing an intended indicator value, and an evaluation representing goodness of the portfolio, based on data including the portfolio and the target indicator value; and
a determination process of determining a portfolio whose evaluation rises using the model, and
the evaluation includes error information indicating a degree of deviation between an indicator of the portfolio and a target indicator value, and cost information indicating a transaction cost required for recombining the plurality of stocks.

The determination device may further include a memory. The memory may store a program for causing the at least one processor to execute each of the processing.

### Supplementary Note 2

The determination device according to Supplementary Note 1, in which in the determination process, the portfolio is determined by inputting an Ising model based on the model to an annealing machine.

### Supplementary Note 3

The determination device according to Supplementary Note 2, in which in the determination process, the at least one processor applies, to the annealing machine, a constraint condition that a profit rate of the portfolio is larger than a profit rate of the target indicator value by a standard or more.

### Supplementary Note 4

The determination device according to Supplementary Note 3, in which in the determination process, the at least one processor applies the constraint condition to the annealing machine while changing the standard, and determines the portfolio relevant to the maximum standard from which a solution is obtained from the annealing machine.

### Supplementary Note 5

The determination device according to Supplementary Note 2, in which in the determination process, the at least one processor applies a constraint condition that limits the number of stocks constituting the portfolio to the annealing machine.

### Supplementary Note 6

The determination device according to Supplementary Note 1, in which the error information represents a standard deviation of a difference between a logarithm of a profit rate of the target indicator value and a logarithm of a profit rate of the portfolio.

### Supplementary Note 7

The determination device according to Supplementary Note 1, in which in the determination process, the at least one processor changes weighting of the cost information with respect to the error information in the evaluation to determine the plurality of portfolios.

### Supplementary Note 8

The determination device according to Supplementary Note 7, in which in the determination process, the at least one processor selects one of the portfolios from the plurality of portfolios based on reference information indicating a predetermined ratio between the error information and the cost information.

According to an example aspect of the present disclosure, there is an exemplary effect that a technology for efficiently determining a portfolio can be provided.

What is claimed is:

1. A determination device comprising:
at least one memory storing instructions, and
at least one processor configured to execute the instructions to:
create a model representing a relationship between a portfolio representing a configuration of a plurality of stocks and a target indicator value representing an intended indicator value, and an evaluation representing goodness of the portfolio, based on data including the portfolio and the target indicator value; and
determine a portfolio whose evaluation rises using the model,
wherein the evaluation includes error information indicating a degree of deviation between an indicator of the portfolio and a target indicator value, and cost information indicating a transaction cost required for recombining the plurality of stocks.

2. The determination device according to claim 1, wherein the at least one processor is further configured to execute the instructions to determine the portfolio by inputting an Ising model based on the model to an annealing machine.

3. The determination device according to claim 2, wherein the at least one processor is further configured to execute the instructions to apply, to the annealing machine, a constraint condition that a profit rate of the portfolio is larger than a profit rate of the target indicator value by a standard or more.

4. The determination device according to claim 3, wherein the at least one processor is further configured to execute the instructions to apply the constraint condition to the annealing machine while changing the standard, and determine the portfolio relevant to the maximum standard from which a solution is obtained from the annealing machine.

5. The determination device according to claim 2, wherein the at least one processor is further configured to execute the instructions to apply a constraint condition that limits the number of stocks constituting the portfolio to the annealing machine.

6. The determination device according to claim 1, wherein the error information represents a standard deviation of a difference between a logarithm of a profit rate of the target indicator value and a logarithm of a profit rate of the portfolio.

7. The determination device according to claim 1, wherein the at least one processor is further configured to execute the instructions to change weighting of the cost information with respect to the error information in the evaluation to determine the plurality of portfolios.

8. The determination device according to claim 7, wherein the at least one processor is further configured to execute the instructions to select one of the portfolios from the plurality of portfolios based on reference information indicating a predetermined ratio between the error information and the cost information.

9. A determination method comprising:
a learning process of creating a model representing a relationship between a portfolio representing a configuration of a plurality of stocks and a target indicator value representing an intended indicator value, and an evaluation representing goodness of the portfolio, based on data including the portfolio and the target indicator value; and
a determination process of determining a portfolio whose evaluation rises using the model,
wherein the evaluation includes error information indicating a degree of deviation between an indicator of the portfolio and a target indicator value, and cost information indicating a transaction cost required for recombining the plurality of stocks.

10. A non-transitory computer-readable medium having stored therein a determination program for causing a computer to execute:
a learning process of creating a model representing a relationship between a portfolio representing a configuration of a plurality of stocks and a target indicator value representing an intended indicator value, and an evaluation representing goodness of the portfolio, based on data including the portfolio and the target indicator value; and
a determination process of determining a portfolio whose evaluation rises using the model,
wherein the evaluation includes error information indicating a degree of deviation between an indicator of the portfolio and a target indicator value, and cost information indicating a transaction cost required for recombining the plurality of stocks.
